(19) United States
(12) Patent Application Publication
(10) Pub. No.: US 2013/0297198 A1
(43) Pub. Date: Nov. 7, 2013

(54) METHOD FOR GENERATING MAP DATA

(71) Applicants: Linde Vande Velde, Merelbeke (BE); Pascal Clarysse, Koksijde (BE)

(72) Inventors: Linde Vande Velde, Merelbeke (BE); Pascal Clarysse, Koksijde (BE)

(73) Assignee: TOMTOM BELGIUM N.V., Gent (BE)

(21) Appl. No.: 13/995,985

(22) PCT Filed: Dec. 20, 2010
(86) PCT No.: PCT/EP2010/070288

§ 371 Date: Jun. 20, 2013

(51) Int. Cl. G01C 21/20

(52) U.S. Cl. CPC G01C 21/206
USPC 701/409

(57) ABSTRACT

A method and system for generating map data is disclosed, wherein the map data represents the inside of a building and/or an enclosed and/or covered area. Location related data is firstly generated by a plurality of mobile devices using at least one non-GPS navigation sensor and at least one GPS sensor, preferably in each mobile device. The location related data is then aggregated and map data determined from the aggregated data.

### FIELD OF THE INVENTION

The present invention relates to a method for generating map data, particularly a method for generating indoor map data from devices having GPS and non-GPS sensors.

### BACKGROUND TO THE INVENTION

Techniques for generating maps have benefited from advances in technology. In particular, the Global Positioning System (GPS) of FIG. 1 and the similar systems may be used to determine continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal allows the receiving device to calculate its three dimensional position by the same geometrical calculation in a known manner. The position and velocity data can be updated in real time on a continuous basis by an unlimited number of users.

As shown in FIG. 1, the GPS system 100 comprises a plurality of satellites 102 orbiting about the earth 104. A GPS receiver 106 receives spread spectrum GPS satellite data signals 108 from a number of the plurality of satellites 102. The spread spectrum data signals 108 are continuously transmitted from each satellite 102, the spread spectrum data signals 108 transmitted each comprise a data stream including information identifying a particular satellite 102 from which the data stream originates. The GPS receiver 106 generally requires spread spectrum data signals 108 from at least three satellites 102 in order to be able to calculate a two-dimensional position. Receipt of a fourth spread spectrum data signal enables the GPS receiver 106 to calculate, using a known technique, a three-dimensional position.

GPS systems, such as that shown in FIG. 1 are commonly used for determining the location of features such as building perimeters, roads, rivers and the like during collection of outdoor mapping data with good accuracy relative to other commonly used methods. For example, vehicles or people equipped with GPS based location determination equipment can travel to, and record the location of, features for mapping. Aerial photographs also allow a wide range of outdoor mapping data to be readily collected and transformed in to maps. Furthermore, historical mapping data may be used in the generation of updated mapping data.

However, GPS signals may be attenuated by walls, floors and other building structures. As a result, GPS signal reception in buildings is often insufficient to allow accurate determination of positions. Furthermore, satellite or aerial views do not generally allow internal features or layout to be determined. Historical mapping data may not cover building interiors and buildings and their interiors may change over time.

Non GPS based location determining sensors that are operable indoors are available. However, these non-GPS sensors are often less accurate than sensors that use GPS based systems. Furthermore, determining internal positions of features and routes within buildings may be time consuming and/or access to some buildings or areas of buildings may be restricted.

Therefore, the present invention addresses the need to generate accurate indoor mapping data.

### SUMMARY OF INVENTION

According to a first aspect of the present invention is a method for generating map data representing the inside of a building and/or an enclosed and/or covered area, the method comprising:
acquiring location related data that has been generated by a plurality of mobile devices (200) using at least one non-GPS navigation sensor (205-220) and at least one GPS sensor (225);
aggregating the location related data; and
determining the map data from the aggregated location related data.

Preferably, the location related data is acquired by each of the mobile devices, said location related data comprising a plurality of locations of the mobile device determined using at least one non-GPS position sensor and at least one GPS position sensor.

The map data may comprise an indication of navigable locations and/or an internal layout and/or a floor plan and/or contextual data such as a use, function or name of a room, area or navigable location.

The at least one non-GPS sensor and/or the at least one GPS sensor may be comprised in at least some, and preferably each, of the mobile devices.

The GPS sensor may be operable to determine at least one GPS location of at least some, and preferably each, of the mobile devices. The at least one non-GPS sensor may be configured to generate navigation data dependant on, or indicative of, a location, movement, bearing, heading distance travelled, orientation, direction, speed, acceleration and/or height of the at least one non-GPS sensor. The mobile devices may be configured to determine estimated location data from the navigation data. The mobile devices may be configured to aggregate estimated location data to form aggregated location data. The location related data may comprise the GPS location data, navigation data, the estimated location data and/or the aggregated location data.

The mobile device(s) may be moved to navigable locations in a building and/or an enclosed and/or covered area and the method may comprise determining associated navigation data using the non-GPS sensors.

The estimated locations and/or the aggregated locations may be comprised in a route trace.

The at least one non-GPS navigation sensor may comprise an inertial sensor, a compass, a gyroscope, an accelerometer, a barometer, a pedometer or the like.

The method may comprise determining at least one estimated location of at least some, and preferably each, of the mobile devices relative to a known location using the navigational data determined using one or more non-GPS sensors. In this way, the estimated locations may be equivalent to artificial probe points or virtual or fictive GPS points. The estimated locations may represent an estimated path taken by the mobile device.

The navigation data may comprise non-geographical parameter values, which may be determined on the fly, and may represent estimated coordinates of an indoor path.

The estimated locations may be 3D locations and may contain or be indicative of x, y and z values.

The known location may be determined using the GPS location data. The method may comprise referencing and/or calibrating the estimated location data using GPS location data, such as a most recent GPS location, which may comprise automatic re-referencing or re-calibration of the non-GPS location data upon receiving new GPS location data. The most recent GPS location data may comprise GPS location data having an accuracy above a predetermined accuracy threshold.

At least some, and preferably each, of the mobile devices may comprise a processor and/or communications apparatus for communicating with a server, which may comprise wireless communication apparatus.

The method may be a method of operating a map data server.

The method may comprise providing the location related data from the at least one mobile device to a server. The method may comprise retrieving the map data from the server using the mobile devices. The method may be performed on the remote server. However, it will be appreciated that the method may additionally or alternatively be performed on the mobile device. For example, although navigational data as determined by the at least one non-GPS sensor may be sent directly to the server, it may be advantageous to determine estimated location data from the navigational data and/or determine aggregated location data on the mobile device before communicating the estimated location data and/or aggregated location data to the server. In this way, for example, navigational data from the non-GPS sensors such as direction, distance, number of steps, speed, pressure and the like, may be processed on the device, and referenced to GPS location data from the GPS sensor, in order to determine estimated locations from the navigational data obtained from the non-GPS sensors. Optionally the estimated locations may be sent to the server, rather than the navigational data from the non-GPS sensors. The estimated location data may be aggregated with other estimated location data collected by the mobile device and used to form aggregated location data, such as an aggregated route trace, before communicating data with the server. By converting raw sensor data such as number of steps or direction into estimated locations on the device, then device specific issues such as the format of the non-GPS sensor data and user specific issues such as providing an average step length for a user in order to determine distance travelled from a number of steps recorded by a pedometer, may be more easily addressed. By performing the above processing on the device, aggregated data that is sent to the server may be less data intensive than raw sensor or estimated location data and/or may reduce the bandwidth required.

The method may comprise determining when a mobile device has entered a building and/or an enclosed and/or covered area and may comprise automatically activating at least one non-GPS sensor when it is determined that the device has entered the building and/or enclosed and/or covered area. The determination of when a mobile device has entered a building and/or an enclosed and/or covered area may comprise comparing a GPS location and/or an estimated location of the mobile device with predetermined map data, such as map data indicating building footprints, perimeters or the like. The determination of when a mobile device has entered a building and/or an enclosed and/or covered area may comprise determining when no GPS signal is detected by the GPS sensor and/or a signal detected by the GPS sensor is insufficient to allow a location to be determined, which may be below a threshold, and/or at least one and optionally a predetermined number of locations determined by the GPS sensor are determinable with an accuracy below a predetermined threshold.

The method may comprise comparing the GPS and/or non-GPS location data to predetermined map data, which may comprise building footprint data, and determining whether the location data is from internally or externally of the building and/or an enclosed and/or covered area. The method may comprise separating data representing the interior of the building and/or enclosed and/or covered area from data representing the exterior of the building and/or an enclosed and/or covered area. The method may comprise processing the interior data separately from the exterior data. The exterior data may comprise the GPS data. The Interior data may comprise the location related data derived from the non-GPS sensors.

The method may comprise determining exits and/or entrances to a building by determining where a location of a mobile device indicated by the GPS location data and/or estimated location data and/or aggregated location data intersects a perimeter of a building indicated in a building footprint and/or where the estimated locations determined from the non-GPS sensors intersect or have a closest approach to GPS locations determined from the GPS data, such as a most recent GPS location. The building footprint may be stored in memory of a mobile device and/or accessible by a mobile device from the server.

The method may comprise determining a speed of at least some, and preferably each, of the mobile devices from the navigation data and/or GPS data, for example, as it enters a building. In this way, it may be possible to discriminate between vehicles and pedestrians, which may optionally be usable to derive contextual data. For example a vehicle being inside a building may be indicative of a car park.

The method may comprise determining at least one floor or building level or height. Determining a building level may comprise determining at least one pressure measurement using the pressure sensor of a mobile device and determining a level or floor or height based on the determined pressure. Determining a building level may comprise determining a number of turns, such as a number of 90° or 180° or greater angle turns, for example, by using a bearing determination device such as an electronic compass or gyro. The number of turns may comprise a number of turns within a predetermined period of time and or predetermined distance travelled.

One or more of the mobile devices may comprise a plurality of non-GPS sensors. The method may comprise using navigational data derived from at least one non-GPS sensor to calibrate at least one other non-GPS sensor. The method may comprise using the determination of when the mobile device has entered the building and/or a number of turns determined by the compass in order to calibrate a height sensor, such as a barometric sensor. The method may comprise determining a ground floor pressure using the pressure sensor when a GPS and/or estimated location of the device is determined to have crossed a perimeter or footprint of the building. The mobile device may be configured to determine a floor or level based on the number of turns in a predetermined timescale and or distance travelled. The direction of the floor change (i.e. up or down) may be determined from a change in pressure determined by the pressure sensor, i.e. an increase in pressure may be associated with descending whilst a decease in pressure may be associated with ascending. In this way, data derived from the compass (i.e. number of levels or floors from the ground floor) may be cross referenced with pressure readings from the pressure sensor in order to associate pressure readings or differentials with a level, floor or height.

The determination of level, height or floor may comprise clustering of location data points, such as clustering location data points by pressure readings and/or an estimation of level based on the number of turns since the device is determined to have entered the building. For example, if all the determined pressure readings are ordered along a pressure axis, then distinct bands or clusterings of pressure readings may be observed. Each of these bands or clusterings of pressure readings may be indicative of a level or floor, and the locations associated with each pressure reading can be assigned a level, height, floor or z-direction location accordingly.

The method may comprise determining at least one pattern in the location related data and/or a series of actions associated with the location related data and determining map data accordingly. The at least one pattern and/or series of actions may be determined using statistical analysis. The at least one pattern and/or series of actions may be determined by comparing time evolved estimated location data with predetermined patterns or profiles. For example, up/down ramps and stairs may be determined by using pressure data and/or identifying turns using orientation or compass data. As another example, the speed with which the mobile device travels as it enters a building or the reading from a pedometer or gyroscope may be indicative of the mobile device being in a vehicle such as a car, or a bicycle or being carried by a pedestrian. For example, an amount of shaking determined by a pedometer and/or gyroscope may be used to discriminate between pedestrians, cyclists and car drivers. In this way, the area in which a vehicle enters the building may be associated with a car park, for example. In another example, location data for a building collected from a variety of users may show many different users congregating in a certain area during the middle of the day, which may be indicative of a canteen at that location. A series of route traces that show a large number of various users going to a particular location at varying times may be indicative of a toilet at that location. It will be appreciated that other patterns indicative of other locations may be applied.

The method may comprise determining inter-level transit locations, such as stairs and/or lifts and/or ramps. Determining inter-level transit locations may comprise determining locations having a level, height or floor intermediate the heights assigned to floors or levels, wherein such intermediate floor or level locations may be indicative of inter-level transit locations. The method may comprise determining time differences or times associated with the locations having intermediate heights. The method may comprise determining those locations having a time difference between successive locations having intermediate heights above a time threshold as being associated with stairs. The method may comprise determining those locations having a time difference between successive locations having intermediate heights below a time threshold as being associated with lifts. The method may comprise determining a spread of locations, such as locations in a horizontal or floor plane, and/or a number of 90° or greater, such as 180° or greater, angle turns made. For example, if a spread of horizontal locations associated with the intermediate height data points is greater than a predetermined amount and/or the height data points are associated with one or more 90° or greater turns or are spread out over a time period that is greater than a predetermined amount of time, then this may be indicative of stairs, whereas if the data points are concentrated in a small horizontal area, i.e. below a predetermined spread, then this may be indicative of a lift.

The method may comprise retrieving contextual data, which may comprise time and/or location data. The method may comprise associating location data determined from the mobile device with the contextual data.

The contextual data may comprise user data such as a calendar or schedule associated with the user, which may comprise time and/or location data such as a meeting time and/or room. The method may comprise cross referencing the estimated location and/or time determined using the non-GPS sensor data with the time and location data comprised in the user data in order to identify locations.

The method may comprise determining the location of corridors, halls and rooms using statistical processing of the estimated location data, such as pattern matching.

The method may comprise providing a mobile device having at least one non-gps position sensor, determining and recording the location of the device in one or more locations.

The method may comprise rendering indoor maps.

According to a second aspect of the invention is an apparatus for generating map data representing the inside of a building and/or an enclosed and/or covered area, comprising a processor (154, 230) operable to acquire location related data that has been generated by a plurality of mobile devices (200) using at least one non-GPS navigation sensor (205-220) and at least one GPS sensor (225), the apparatus being operable to aggregate the location related data; and determine the map data from the aggregated location related data.

According to a third aspect of the present invention, there is provided a computer program element comprising computer program code means to make a computer execute the method as set forth above in relation to the first or third aspects of the invention or to implement the apparatus as set forth in the second or fourth aspects of invention.

The computer program element may be embodied on a computer readable medium.

According to a fourth aspect of the present invention is an apparatus when programmed with the computer program product of the third aspect.

Alternatively or additionally, there may also be provided at least one of the following: the creation of artificial probe points using different sensors, allowing the harvesting and processing of indoor data with data probe processing algorithms; the combination of creating artificial probe points and extending them to traces from GPS points, and later filtering using building footprint maps, the indoor probe points from outdoor probe points (some indoor may be real GPS points), to produce indoor probe data for separate processing; the population of indoor maps with context information collected from a variety of sources; processes to identify particular indoor attributes.

Advantages of embodiments are set out hereafter, and further details and features of each of these embodiments are defined in the accompanying dependent claims and elsewhere in the following detailed description.

It will be appreciated that features described in relation to any of the above aspects of invention may also optionally be applicable to any other aspect of invention. Furthermore, it will also be appreciated that method features analogous to any described apparatus features are intended to fall within the scope of the disclosure and vice versa.

### BRIEF DESCRIPTION OF THE DRAWINGS

At least one embodiment of the invention will now be described, by way of example only, with reference to the accompanying drawings, in which:

FIG. 1 is a schematic illustration of an exemplary part of a Global Positioning System (GPS) usable by a navigation device;

FIG. 2 is a schematic of an example of a mobile device for collecting location data from within a building;

FIG. 3 is a schematic of a system for collecting location data comprising a mobile device of FIG. 2 and a server;

FIG. 4 is a flow chart representing a method for generating map data from data collected using one or more mobile devices of FIG. 2;

FIG. 5 is a schematic of an example of a building for which internal mapping data is required;

FIG. 6 is a footprint for the building shown in FIG. 3;

FIG. 7 is a schematic showing a plurality of route trace location data provided by a plurality of mobile devices, overlayed on a floorplan map; and

FIG. 8 is a representation of heights or z-directions associated with a series of locations determined within a building having 5 floors or levels.

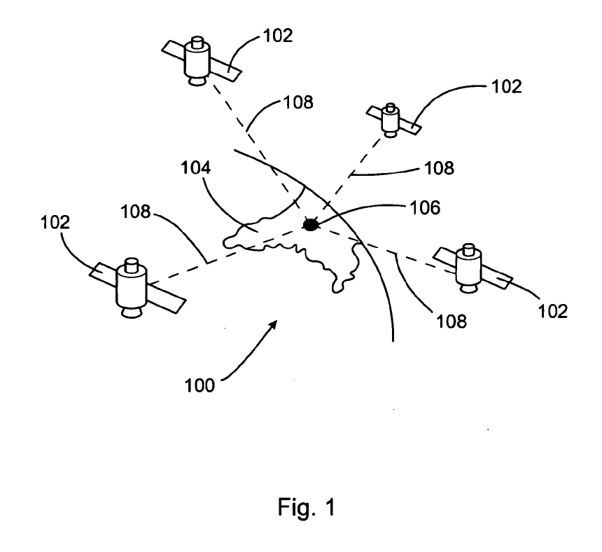

### DETAILED DESCRIPTION OF EMBODIMENTS

Throughout the following description identical reference numerals will be used to identify like parts.

As indicated above, many traditional techniques used in the collection of mapping data such as those relying solely on GPS based systems may be ineffective inside buildings and enclosed spaces.

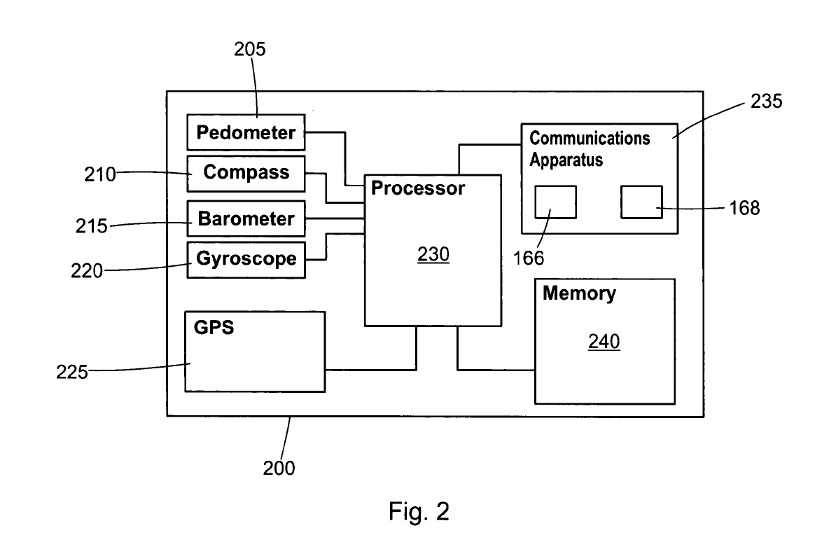

FIG. 2 shows a mobile device 200 that comprises non-GPS sensors 205, 210, 215, 220 that are operable to obtain navigational data and/or at least partial estimates of location. For example, the mobile device 200 may be equipped or equipable with one or more sensors such as pedometers 205, compasses 210, pressure sensors 215 such as barometers, gyroscopes 220, inclinometers and the like. The mobile device 200 is also equipped or equipable with a GPS sensor 225 for use when sufficient signal 108 from GPS satellites 102 is available. The GPS 225 and/or non-GPS 205, 210, 215, 220 sensors may optionally be built into the mobile device 200 or may be connected to the mobile device 200, for example as part of a retrofit or as a plug-in or accessory. The GPS sensor 225 and non-GPS sensors 205, 210, 215, 220 are operably coupled to a processor 230. The mobile device 200 further comprises communications apparatus 235, which includes a transmitter 166 and receiver 168 for communicating with other devices and/or a server 150. The mobile device 200 also comprises a memory 240 for storing navigational data derived from the non-GPS sensors or GPS location data derived from the GPS sensor 225, estimated location data derived from the navigational data and/or aggregated routes derived from the estimated location data and any data required in order to determine the estimated location data from the navigational data, such as an average user stride length. Suitable mobile devices 200 are, for example, based on mobile communications devices such as smart-phones, for example i-phones®, and the like, portable computers such as laptop or tablet PCs, and the like, personal data assistants and dedicated navigation devices.

The non-GPS sensors can be operated to collect navigation data such as a number of steps via the pedometer 205, a bearing or direction via the compass 210, a pressure using the pressure sensor 215 and/or an orientation using the gyroscope 220.

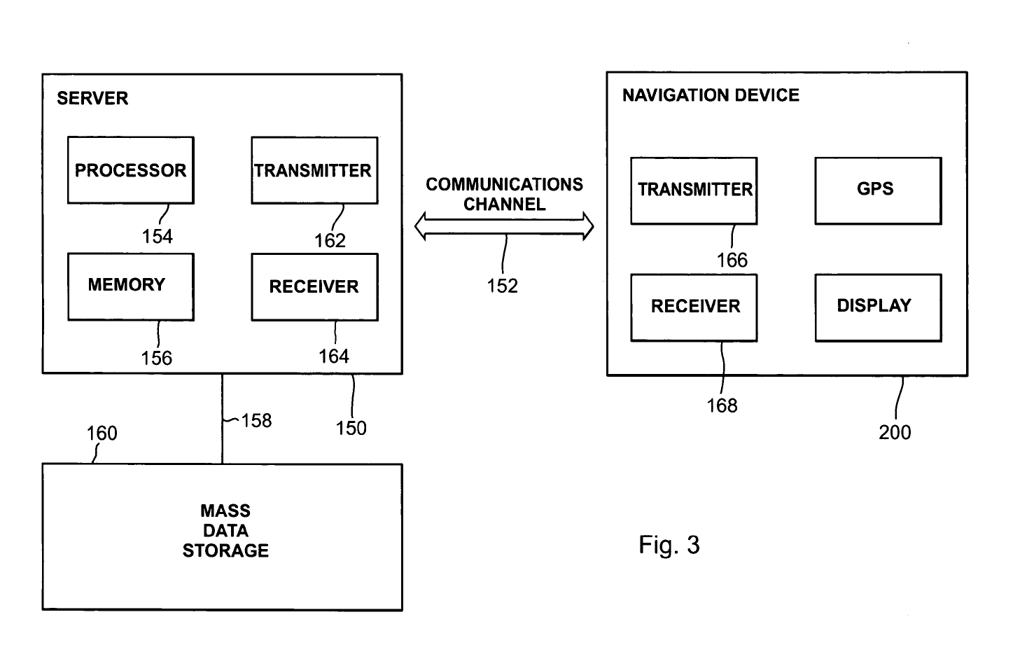

As shown in FIG. 3, the mobile device 200 is capable of establishing a data session, if required, with network hardware of a “mobile” or telecommunications network. Thereafter, through its network service provider, the mobile device can establish a network connection (through the Internet for example) with a server 150. As such, a “mobile” network connection can be established between the mobile device 200 (which can be, and often times is, mobile as it travels alone and/or in a vehicle) and the server to provide a “real-time” or at least very “up to date” gateway for information.

The establishing of the network connection between the mobile device 200 (via a service provider) and another device such as the server 150, using the Internet for example, can be done in a known manner. In this respect, any number of appropriate data communications protocols can be employed, for example the TCP/IP layered protocol. Furthermore, the mobile device 200 can utilize any number of communication standards such as CDMA2000, GSM, IEEE 802.11 a/b/c/g/n, etc.

For example, an the internet connection can be utilised by the device 200, which can be achieved via data connection via a mobile phone or mobile phone technology within the device 200 for example.

Although not shown, the mobile device 200 includes its own mobile telephone technology within the mobile device 200 itself (including an antenna for example, or optionally using the internal antenna of the mobile device 200). The mobile phone technology within the mobile device 200 can include internal components, and/or can include an insertable card (e.g. Subscriber Identity Module (SIM) card), complete with necessary mobile phone technology and/or an antenna for example. As such, mobile phone technology within the navigation device 200 can similarly establish a network connection between the mobile device 200 and the server 150, via the Internet for example, in a manner similar to that known in the art for mobile devices.

The network connection may also be provided intermittently, for example, when the mobile device 200 is connected to a network, such as the internet, directly via a wi-fi or cabled connection or by connecting the device, which may include wireless connection, with an intermediary device such as a personal computer that has a network connection.

In some embodiments, the network connection is not direct. For example, the mobile device 200 need not be directly connected to the remote server 150, but instead data may be downloaded from the device 200 into the intermediary device and thereafter (which may be at a later time or date and may be after the mobile device 200 has been disconnected) the intermediary device may forward the data to the remote server 150.

In FIG. 3, the mobile device 200 is depicted as being in communication with the server 150 via a generic communications channel 152 that can be implemented by any of a number of different arrangements. The communication channel 152 generically represents the propagating medium or path that connects the mobile device 200 and the server 150. The server 150 and the mobile device 200 can communicate when a connection via the communications channel 152 is established between the server 150 and the mobile device 200 (noting that such a connection can be a data connection from the mobile device 200, a direct connection via personal computer via the internet, etc.).

The communication channel 152 is not limited to a particular communication technology. Additionally, the communication channel 152 is not limited to a single communication technology. For instance, in particular embodiments the channel 152 includes one or more of several communication links that use a variety of technology. For example, the communication channel 152 can be adapted to provide a path for electrical, optical, and/or electromagnetic communications, etc. As such, the communication channel 152 includes, but is not limited to, one or a combination of the following: electric circuits, electrical conductors such as wires and coaxial cables, fibre optic cables, converters, radio-frequency (RF) waves, the atmosphere, free space, etc. Furthermore, the communication channel 152 can include intermediate devices such as routers, repeaters, buffers, transmitters, and receivers, for example.

In one illustrative arrangement, the communication channel 152 includes telephone and computer networks. Furthermore, the communication channel 152, in particular embodiments is capable of accommodating wireless communication, for example, infrared communications, radio frequency communications, such as microwave frequency communications, etc. Additionally, the communication channel 152 can accommodate satellite communication.

The server 150 includes, in addition to other components which may not be illustrated, a processor 154 operatively connected to a memory 156 and further operatively connected, via a wired or wireless connection 158, to a mass data storage device 160. The mass storage device 160 contains a store of navigation data and map information, and can be a separate device from the server 150 or can be incorporated into the server 150. The processor 154 is further operatively connected to transmitter 162 and receiver 164, to transmit and receive information to and from mobile device 200 via communications channel 152. The signals sent and received can include data, communication, and/or other propagated signals. The transmitter 162 and receiver 164 may be selected or designed according to the communications requirement and communication technology used in the communication design for the navigation system 200. Further, it should be noted that the functions of transmitter 162 and receiver 164 may be combined into a single transceiver.

As mentioned above, the mobile device 200 can be arranged to communicate with the server 150 through communications channel 152, using transmitter 166 and receiver 168 to send and receive signals and/or data through the communications channel 152, noting that these devices can further be used to communicate with devices other than server 150. Further, the transmitter 166 and receiver 168 are selected or designed according to communication requirements and communication technology used in the communication design for the navigation device 200 and the functions of the transmitter 166 and receiver 168 may be combined into a single transceiver. Of course, the navigation device 200 comprises other hardware and/or functional parts, which will be described later herein in further detail.

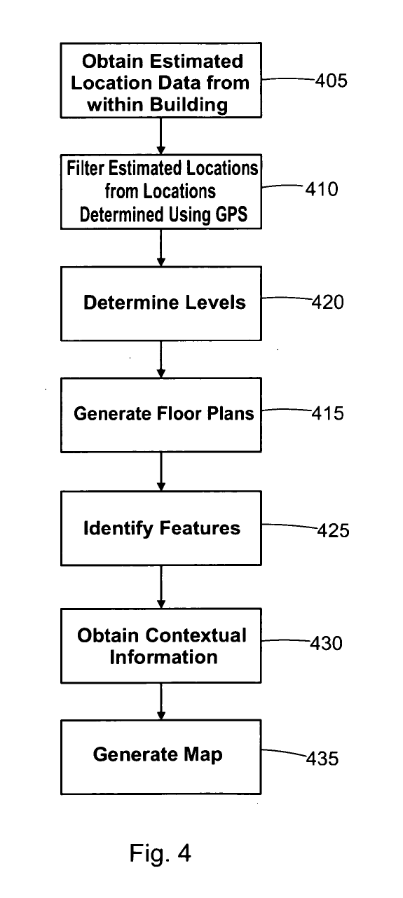

A process for generating mapping data using one or more of the mobile devices 200 is shown in FIG. 4.

The present invention utilises estimated location data for the inside of buildings, the estimated location data being derived from navigation data collected by the non-GPS sensors 205, 210, 215, 220 of the mobile devices 200, as indicated by step 405 in FIG. 4. Conveniently the data may be collected using mobile devices 200 that a user will generally carry, such as the user's mobile smartphone, when suitably provided with the required GPS and non-GPS sensors 205-225, and configured to perform the operations described herein.

In one embodiment, the estimated location data is uploaded to the server 150 for processing using the communications channel 152. However, in an alternative embodiment, the navigation data determined using the non-GPS sensors is processed by each mobile device 200 in order to determine estimated location data relating to the inside of the building. Optionally, the estimated location data is then aggregated with other estimated location data and/or GPS location data on the mobile device 200. The aggregated location data can then be communicated to the server 150 via the communications channel 152 and further aggregated with aggregated and estimated location data collected and supplied by other mobile devices 200. The required functionality on the mobile device 20 is controlled by a device controller implemented by a custom program or application (app). The server 150 is then configured to process the estimated location data received from a plurality of mobile devices 200 and process this in order to determine mapping data.

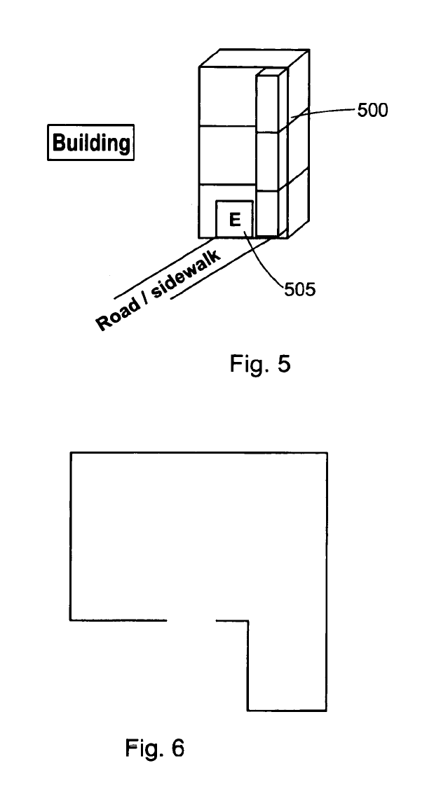

FIG. 5 illustrates a building 500 having an entrance 505. Although the present example is illustrated with reference to a building, it will be appreciated that the method is equally applicable to any enclosed area or generally to areas lacking in or having insufficient GPS coverage to reliably determine a GPS location.

The process of determining user locations within a building starts when the user is outside of the building. At this point, the user's mobile device 200 is operable to determine its location using the GPS sensor 225 using techniques known in the art. Known map data, such as street plans and building footprints, such as that shown in FIG. 6, can be stored in a memory 240 of the mobile device and/or accessible from a memory 156 or data store 160 on the server 150 using communications channel 152. The user's location as determined by the GPS system 225 can be compared with the known map data to determine when the user is approaching a building or enclosed area.

The mobile device 200 is operable to automatically determine when a user has entered the building or enclosed space. For example, the mobile device 200 in some embodiments is operable to determine when a GPS signal drops beyond a certain threshold and/or compare the user's location as determined by the GPS sensor 225 with the location of the perimeter of the building 500 contained in the known map data, and determine that the user has entered the building 500 accordingly. When it is determined that the user is entering, entered or is about to enter the building 500, the device controller automatically activates the non-GPS sensors 205-220 of the mobile device 200, such as a pedometer 205, barometer 215, compass 210 and/or a gyroscope 220. Location data obtained from the GPS sensor 225 at this point can be used to provide a reference location from which estimated locations within the building can be determined. The estimated locations may be determined relative to the GPS reference location using navigation data from the non-GPS sensors 205-220, which may be used in conjunction with pre-stored calibration data such as average user stride length for use with the pedometer, which may be prestored in the memory 240 of the mobile device 200 or the memory 156 or data store 160 of the server 150 via the communications channel 152.

For example, navigation data representative of a number of steps taken by a user can be determined using a pedometer and multiplied by an average step length for the user in order to estimate a distance travelled. A pressure sensor such as a barometer can be used in order to determine navigation data representative of pressure data, which may be used to estimate a height or level. An electronic compass or the like may be operable to determine navigation data in the form of a heading or bearing. If the mobile device is in a vehicle, then it may have access to sensors on the vehicle that are operable to determine navigation data such as distance travelled and speed. By using navigation data from one or more of these non-GPS sensors, it will be appreciated that an estimated location relative to the reference location determined using the GPS sensor 225 is determined in certain modes of operation.

The GPS sensor 225 can be used to recalibrate and/or update the estimated locations. For example, if a user walks near a window or door, the mobile device 200 may pick up enough signal from the GPS satellite system 102 to determine a location using the GPS based sensor. In this case, the mobile device is operable to use the accurate GPS derived location to update the estimated locations determined using the non-GPS based sensors, i.e. the estimated locations may always be derived from the latest sufficiently accurate location reading derived from the GPS sensor 225.

Optionally, the mobile device is operable to filter the estimated locations from the locations determined using the GPS, as indicated in step 410 of FIG. 4. In this way, the estimated locations can be processed separately, as these estimated locations may be less accurate than the locations obtained using the GPS sensor and are subjected to processing in the form of aggregation in order to obtain usable estimated location data to a required accuracy. In an alternative or additional embodiment, such filtering of estimated locations from GPS derived data may be performed on the server 150. The filtering can be performed using know maps, for example 2d, 2.5d or 3d maps, representative of building footprints, with locations determined indoors being processed differently from those obtained outdoors. Alternatively, the GPS and non-GPS data and locations obtained from the data can be distinguished, and filtered, based on characteristics or identifiers of the data. The filtering can provide improved data processing efficiency.

An important and difficult aspect of using estimated location data for the interior of buildings or enclosed areas is determining which floor or level of a building the navigational data/estimated location relates to. Unless separation of the estimated location data by floor or level is taken, then the aggregated route trace data for every floor would be superimposed, which may lead to misleading and inaccurate map data.

Various techniques are contemplated for determining a floor, level, height or z-direction associated with each estimated location point. For instance, the pressure sensor of the mobile device can be used to determine pressure at a location, which is generally dependent on height. However, prevailing atmospheric pressures can vary. One way of associating the determined pressure data with floor or level is by arranging or clustering the pressure (or height or z-direction) readings on a pressure (Z) axis, as shown in FIG. 8. It can be seen from this that preferential bands of common or similar pressures are formed. These bands may be indicative of floors or levels. Locations having a pressure between bands may be indicative of stairs, lifts, inter-floor ramps and the like.

Another technique of determining level is through use of other non-GPS sensors 205, 210, 220, which is optionally be used to cross reference the pressure sensor 225 in order to assign levels or floors to the pressure data.

For example, if a vehicle comprising a mobile device 200 equipped with a GPS sensor 225, a barometer 215 and a compass 210 or gyro is driven into an underground car park of an office block, the GPS sensor of the mobile device 200 records the location of the vehicle until it reaches the entrance to the car park. At this point, by referencing the GPS location data to existing streetplan and/or building footprint data, the mobile device 200 is able to determine that it is entering a building 500 or enclosed space, whereupon the non GPS sensors, i.e. the barometer 215 and compass 210 are activated. A floor or level at which the vehicle entered the building may be associated with a ground floor and an associated pressure for the ground floor may be determined using the barometer 215 at this point. The heading of the mobile device 200 (and thereby the vehicle) may be determined using the compass 210. If the compass 210 determines that the mobile device 200/vehicle has made a tight 90° or greater, e.g. 180° or greater turn within a predetermined distance travelled, and that this 90° or 180° turn is associated with a pressure change determined by the barometer 215, then this may be indicative of the vehicle using an up or down ramp. The direction of the ramp, i.e. up or down, can be determined by whether or not the pressure reading increases or decreases. By this technique, it is possible to determine that the mobile device 200 has gone up or down one floor and can associate the measured pressure with that floor or level. For example, it could be determined whether a car has parked at the +2, +1, −1, −2 or any other level, with the barometer information being used to determine whether the car has moved up or down levels, and the associated turn information from the gyro or compass being used to determine the number of the level.

As an alternative example, a person having a smartphone 200 equipped with a GPS location sensor 225, compass 210, barometer 215 and pedometer 205 enters the building 500 from outside of the building 500. As in the previous example, the mobile device 200 is operable to determine when the perimeter of the building 500 has been crossed and activates the non-GPS sensors 205-220. Based on the last known GPS location as a starting point, the position of the mobile device 200 in the floor or horizontal plane (i.e. x and y) relative to the last known GPS location may be determined using the pedometer 205 and the compass 210. Data from the non-GPS sensors 205-220 can be used to determine a sudden slowing of the speed of the mobile device 200 followed by a series of sharp 180° turns detected by the compass 210 and associated with a change in the pressure determined by the barometer 215. This case may be indicative of stairs and a floor or level can thus be determined by a number of turns made and used to calibrate the pressure data. On the other hand, if a cloud of location points, for example from many different devices, are found around one location, and tracking of subsequent movement and associated barometer data indicates rapid movement to another floor, for example with little associated horizontal movement, then that may indicate the presence of an elevator. Stairs in contrast may have a less dense cloud of points associated with them, and tracking of subsequent movement and barometer data may indicate slower movement to another floor.

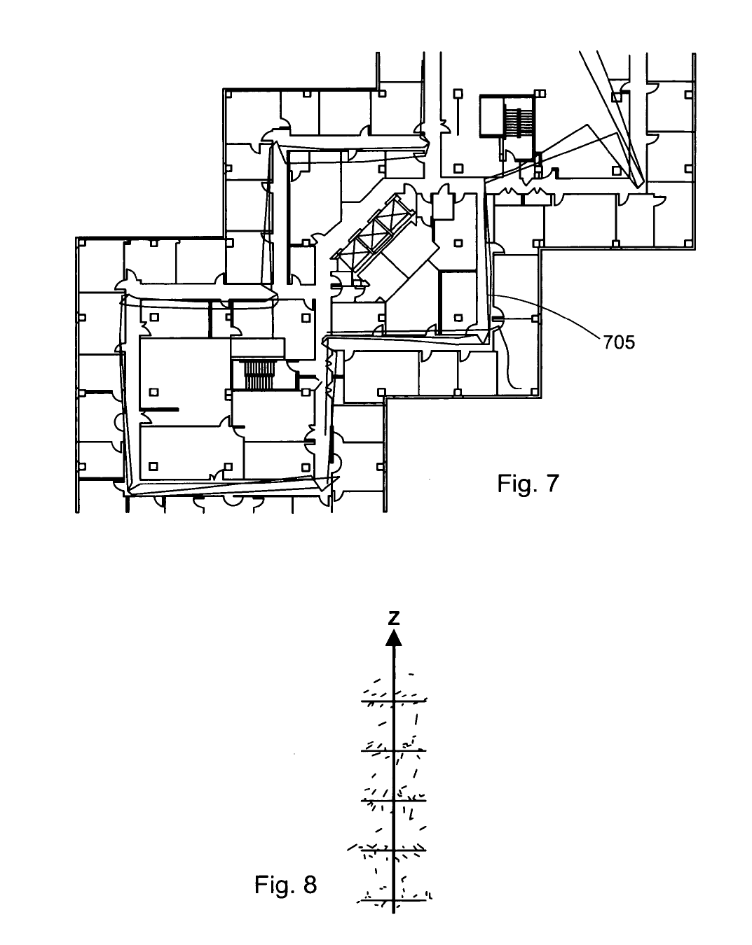

Once the floors or levels have been identified, then the floor plans can be determined by separating the estimated location data by floor or level. The estimated location data associated with a particular floor or level, and optionally location data derived from the GPS sensor 225 if applicable, is used to generate floor plans for the building, as indicated in step 415 of FIG. 4. This comprises aggregating the estimated location data for each floor or level and using this to determine navigable locations on that floor or level. In an embodiment, estimated location data stored on the mobile device 200, which can be estimated location data collected over an extended period of time, is aggregated together to provide an aggregated route trace, as shown in FIG. 7. The aggregated route trace 705 from the mobile device 200 is then, for example, communicated to the server 150 via the communication channel 152, whereupon it may be further aggregated with route traces or aggregated route traces 705 for the particular building that have been determined and supplied by other mobile devices 200. For example, the server may be part of a “user community”, such as TomTom Map Share®, wherein many mobile devices 200 provide estimated location data, in this case in the form of aggregated location data collected by them, and in turn benefit from the resulting map data generated both by the user's mobile device 200 and other mobile devices 200. This method also saves cost and effort in requiring a cartographer to visit each building or enclosed area. Furthermore, this system may be operable to obtain mapping data for buildings for which access may be problematic. The further aggregated data is less sensitive to distortion of the data by user specific routes, such to a user's desk, as the route traces are obtained from a variety of mobile devices belonging to a variety of users. By separating GPS from non-GPS derived location data and/or internal from external location data, the processing may be streamlined by avoiding unnecessary processing of relatively accurate GPS data. By using non-GPS sensors 205-225 comprised in mobile devices 200, the data may be logged by a larger number of users and without having to provide additional equipment. Any loss of accuracy in the estimated location data may be compensated by the larger amount of data that may be available and that may be incorporated into the map data generation processing via the aggregating technique.

In general, the aggregated data is subjected to statistical processing by the server in order to determine pathways or routes that users navigate to. The aggregated or further aggregated route traces for a particular building formed from the estimated location data are indicative of areas of the building that are navigable, such as corridors and rooms. Corridors and public areas that are intensively used may be particularly visible from this aggregated or further aggregated route trace data 705, as shown in FIG. 7. For example, it is possible to identify main corridors or halls, or other connections between entrances and exits. If preferred, an inverse or negative of the aggregated or further aggregated route trace data may be taken. The inverse or negative maybe indicative of walls or obstacles and results in a map image much more akin to a conventional map image.

Whilst the above methods are useful for generating floor plans comprising wall outlines and indications of navigable areas such as corridors and rooms, it is beneficial if contextual information is added to the floor plans. For example, reception floors, names, lifts, meeting rooms, fire exits or any other suitable features may be obtained from such contextual information. A log, for example of location data, enriched with contextual information can subsequently be interpreted to obtain further information in some embodiments.

Patterns in the estimated location data and/or the navigation data obtained from one or more of the non-GPS sensors and/or GPS location data may be analysed to identify features, for example, by using statistical analysis and/or by comparison with predetermined signatures or typical patters and/or by comparison with templates or profiles or the like. For example, as detailed above, up/down ramps and stairs may be determined by using pressure data and/or identifying tight turns using compass data. As another example, the speed with which the mobile device travels as it enters a building or the reading from a pedometer or gyroscope may be indicative of the mobile device being in a vehicle such as a car, or a bicycle or being carried by a pedestrian. In this way, the area in which a vehicle enters the building may be associated with a bicycle or car park, for example. In another example, further aggregated route traces that show many different users congregating in a certain area during the middle of the day may be indicative of a canteen at that location. A series of route traces that show a large number of various users going to a particular location at varying times may be indicative of a toilet at that location. It will be appreciated that other patterns indicative of other locations may be applied.

Another important method for obtaining contextual data is from user data stored on or accessible by the mobile device. For example, if a diary, calendar or agenda functionality is provided on or accessible by the user's mobile device, then this may be used, for example automatically, to cross reference times and locations contained in the stored or accessed user data with the estimated locations determined using the non-GPS sensors for the given times. The agenda information may contain meeting room information. For example, if an agenda indicates that a user of a mobile device 200 has a meeting from 10 h00 to 12 h00 in the “Blaue room” on the 7^{th} floor, this information may be linked to the estimated location data determined for this time, such that the room name and level or floor number can be identified and incorporated into the map data.

As indicated as step 435 in FIG. 4, map data may be generated from the floor plans, floor or level data and populated with the determined or retrieved contextual data. The map data derived from the estimated (and GPS) location data supplied by the mobile devices 200 may then be provided back to the mobile devices 200 from the server in order to help them navigate and may be updated at periodic or user selected intervals, in order to reflect the improved map data as the volume of location data derived from the mobile devices 200 increases.

As detailed above, the system may be operable to collect and process estimated location data of varying accuracy from a number of mobile devices 200 and use the estimated location data to generate accurate and meaningful map data, even for locations for which a GPS signal is weak or unavailable and for locations that may be difficult to access. Furthermore, by using mobile devices 200 that are self contained and widely available, in conjunction with the methods described herein and use of a “user community”, a large amount of map data may be collected without a vast investment of resource by any individual organisation.

By separating GPS and non-GPS derived location data, the processing may be streamlined. By using sensors comprised in self contained mobile devices, the data may be logged by a large number of users and without having to provide them with additional equipment. Any loss of accuracy in the location data from this approach may be compensated by the larger amount of data that may be available and that may be incorporated into the map data generation processing via the aggregating technique.

It will also be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

Whilst embodiments described in the foregoing detailed description refer to GPS, it should be noted that the mobile device 200 may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location, such as location determination systems based on image recognition, laser based systems and/or user input.

In addition, whilst various techniques for identifying features such as stairs or lifts have been advantageously described, it will be appreciated that not all of these techniques need be employed or that varying combinations of techniques or indeed further techniques that are not described in detail herein but would be apparent to a skilled person in view of the teachings of the present application may be used instead.

Furthermore, various examples of non-GPS sensors have been described. It will be appreciated that a suitable mobile device need not have the non-GPS sensors described but may instead have alternative or varying combinations of non-GPS sensors, which may include non-GPS sensors other than those described herein that would be apparent to a person skilled in the art in view of the teaching of the present application.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst the described embodiments implement certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A method for generating map data representing the inside of a building and/or an enclosed and/or covered area, the method comprising:
acquiring location related data that has been generated by a plurality of mobile devices using at least one non-GPS navigation sensor and at least one GPS sensor;
aggregating the location related data; and
determining the map data from the aggregated location related data.

2. The method according to claim 1, wherein the mobile devices are configured to determine navigation data using at least one non-GPS sensor, the navigation data being relative to a known location, such that at least one estimated location of the mobile device is determinable from the navigation data and the known location.

3. The method according to claim 1, wherein the method comprises providing location related data and/or aggregated location related data from the at least one mobile device to a server.

4. The method according to claim 1 comprising determining at least one pattern in the location related data and/or a series of actions associated with the location related data and determining map data accordingly.

5. The method according to claim 1, wherein the method comprises determining when a mobile device has entered a building and/or an enclosed and/or covered area and automatically activating at least one non-GPS sensor when it is determined that the device has entered the building and/or enclosed and/or covered area.

6. The method according to claim 1, wherein the method comprises filtering location related data relating to inside a building and/or an enclosed and/or covered area from location related data relating to outside of a building and/or an enclosed and/or covered area, and selectively aggregating the estimated location data relating to inside a building and/or an enclosed and/or covered area.

7. The method according to claim 1, wherein the method comprises determining exits and/or entrances to a building by determining where a location of the at least one mobile device indicated by the location related data intersects a perimeter of a building indicated in a building footprint and/or where the estimated locations of the mobile device determined from the non-GPS sensors intersects or has a closest approach to locations of the mobile device determined from GPS data.

8. The method according to claim 1, wherein the method comprises determining a speed of the mobile device from the location related data and determining whether the mobile device is associated with a vehicle or a pedestrian and determining contextual data associated with at least one location accordingly.

9. The method according to claim 1, wherein the at least one mobile device comprises a plurality of non-GPS sensors and the method comprises using data from at least one non-GPS sensor to characterise or calibrate data from at least one other non-GPS sensor.

10. The method according to claim 1, the method comprising determining at least one floor or building level or height associated with at least one estimate location, the determination of floor, building level or height comprising determining at least one pressure measurement using the pressure sensor of the mobile device and/or determining a number of turns using a bearing determination device and/or clustering of estimated heights or at least one height dependent parameter determined by a non-GPS sensor.

11. The method according to claim 10, wherein the method comprises determining inter level transit locations by determining locations having an associated height or height dependent parameter intermediate the heights or height dependent parameter values assigned to floors or levels.

12. The method according to claim 11, wherein the method comprises determining time differences or times associated with the locations having intermediate heights and classifying inter-level transit locations accordingly.

13. The method according to claim 1, wherein the method comprises determining contextual data associated with a user of the mobile device and/or associated with a pattern of navigation related data and/or associated with a behavioural pattern over time and determining map data using the contextual data and location related information.

14. The method according to claim 13, wherein the contextual data associated with the user comprises a calendar or schedule.

15. Apparatus for generating map data representing the inside of a building and/or an enclosed and/or covered area, comprising:
a processor operable to acquire location related data that has been generated by a plurality of mobile devices using at least one non-GPS navigation sensor and at least one GPS sensor, the apparatus being operable to aggregate the location related data; and determine the map data from the aggregated location related data.

16. A non-transitory computer readable medium comprising program segments which, when executed on a processor of a navigation device, perform the method for generating map data representing the inside of a building and/or an enclosed and/or covered area the method comprising:
acquiring location related data that has been generated by a plurality of mobile devices using at least one non-GPS navigation sensor and at least one GPS sensor;
aggregating the location related data; and
determining the map data from the aggregated location related data.
